(19) United States
(12) Patent Application Publication
(10) Pub. No.: US 2006/0019218 A1
(43) Pub. Date: Jan. 26, 2006

(54) Combined interproximal reduction (IPR) disc/measurement tool

(76) Inventor: Eric E. Kuo, Foster CIty, CA (US)

Correspondence Address: ALIGN TECHNOLOGY, INC.;ATTENTION: SCOTT SMITH, 881 MARTIN AVENUE, SANTA CLARA, CA, 95050, US

(21) Appl. No.: 10/894,555

(22) Filed: Jul. 20, 2004

(51) Int. Cl. A61C 19/04; A61C 5/00

(52) U.S. Cl. 433/166; 433/215

(57) ABSTRACT

System and methods to perform interproximal reduction are disclosed. The system includes a series of discs with disc thicknesses calibrated to preset increments; and a shank coupled to each disc.

### BACKGROUND

The present invention relates to systems and methods for performing interproximal reduction (“IPR”).

The orthodontics industry is continuously developing new techniques for straightening teeth that are more comfortable and less detectable than traditional braces. One such technique has been the development of disposable and removable retainer-type appliances. As each appliance is replaced with the next, the teeth move a small amount until they reach the final alignment prescribed by the orthodontist or dentist. This sequence of dental aligners is currently marketed as the Invisalign® System by Align Technology, Inc., Santa Clara, Calif.

One problem experienced during treatment is a residual crowding of adjacent teeth due to insufficient interproximal reduction (IPR). This can be caused for example, when a doctor orders a series of appliances with a programmed amount of IPR built into the appliances, but does not deliver the same amount of IPR to the teeth themselves. As a result, the mismatch results in residual crowding and compromised appliance fit. This residual crowding can impede complete tooth alignment, and generally necessitates further abrasion reduction. Another problem is the occurrence of residual spaces between adjacent teeth due to excessive IPR. IPR represents a total amount of overlap between two teeth during a course of treatment. Such overlap must be treated by the clinician by removing material from the surface of the tooth. During the IPR procedure, a small amount of enamel thickness on the surfaces of the teeth is removed to reduce the mesiodistal width and space requirements for the tooth. The IPR procedure is also referred to as stripping, reproximation, and slenderizing. IPR is typically employed to create space for orthodontic treatment in cases where the teeth should not be moved only outwards (buccally of facially) or where the teeth are misshaped in the width dimension

IPR is typically done using a bur attached to a dental handpiece. The bur is applied against the region to be stripped, reproximated or slenderized. In the prior art, the measurement step with calibrated instruments are preceded by the abrasion reduction step as a separate clinical step. To measure the IPR gap, a gauge is typically used. U.S. Pat. No. 5,044,951 to Sheridan describes a interproximal probe with a centrally located handle provided with a pair of oppositely-extending single tips or multiple, elongated, graduated cylinders which terminate in graduated ends, for insertion in the interdental spaces and periodontal cavities. Additionally, U.S. Pat. No. 6,413,086 to Womack discloses an interproximal gauge for determining a width of a gap between adjacent teeth. The gauge includes a plurality of blades. Each of the blades includes a key portion configured for placement in the gap. The key portion exhibits a predetermined thickness, the predetermined thickness being different for different ones of the blades. A handle adjoins the key portion and includes notches having numerical values representing the predetermined thickness. In operation, one of the plurality of blades is selected having the predetermined thickness that is substantially equivalent to the width, and the notches of the blade are interpreted to determine the width of the gap.

### SUMMARY

System and methods to perform interproximal reduction are disclosed. The system includes a series of abrasive discs with disc thicknesses calibrated to preset increments; and a shank coupled to each disc.

In another aspect, a method to perform interproximal reduction (IPR) includes selecting an abrasive disc from a series of discs with disc thicknesses calibrated to preset increments, the disc coupled to a shank and adapted to form a preselected gap based on the disc thickness; inserting the shank into a dental handpiece; and applying the disc to a tooth to create the preselected gap.

Advantages of the system may include one or more of the following. The system allows a user to quickly select a disc for IPR. Additionally, the system avoids the inconvenience of applying the disc to the tooth, removing the disc and measuring the gap using another tool, and reapplying the disc until the desired gap is achieved. The system also minimizes the risk of creating an incorrect gap since the disc is precalibrated.

The use of discs of different measured thicknesses also enables the user to begin the reduction with a thinner disc and gradually step up to thicker discs, until the desired amount of space is created. The abrasion step itself is performed with calibrated instruments such that the resulting space created by the IPR process reflects the calibration built into the instruments, thereby eliminating the need for a separate measurement step after the abrasion procedure is performed.

### BRIEF DESCRIPTION OF THE DRAWINGS

FIG. 1 shows an exemplary set of discs in accordance to aspects of the present invention.

FIGS. 2A-2C illustrate in more detail the top side, bottom side and dual side abrasive positions.

FIGS. 3-5 illustrate various exemplary embodiments of sets of discs.

### DESCRIPTION

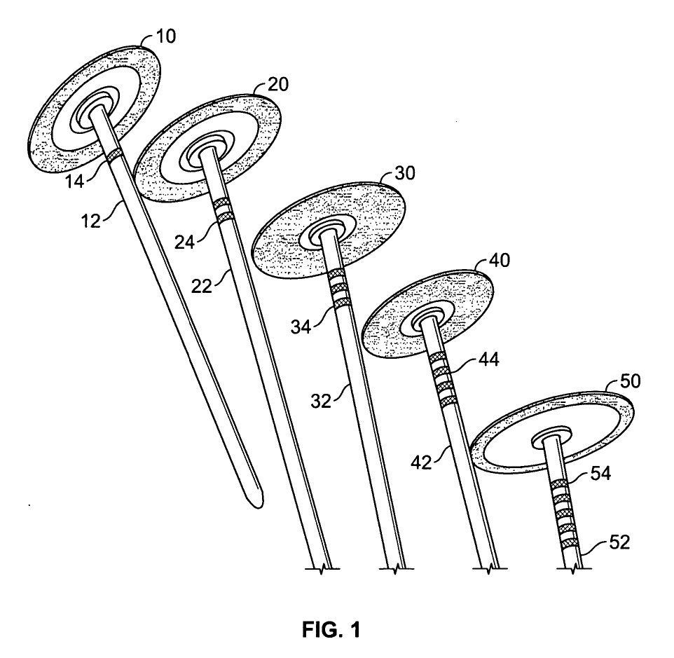

FIG. 1 shows an exemplary system to perform interproximal reduction. The system includes a series of discs 10, 20, 30, 40 and 50 with disc thicknesses calibrated to preset increments. Abrasive-coated discs or series/sequence of discs are provided with thickness calibrated to specific increments, notably 0.1 mm and 0.25 mm increments. For example, one set of discs can have a sequence of thicknesses of 0.1, 0.2, 0.3, 0.4 and 0.5 mm, while another set can have a sequence of thicknesses of 0.25, 0.5, 0.75, 1.0 and 1.25. Other thickness increments can be used as well.

Each of discs 10, 20, 30, 40 and 50 is connected to a shank 12, 22, 32, 42 and 52, respectively. Additionally, one or more indicators 14, 24, 34, 44, and 54 are positioned on the shanks 12, 22, 32, 42 and 52.

The disc/shank combination is marked to indicate the thickness of the disc. In the embodiment of FIG. 1, each line on the shank is used to indicate the thickness in 0.1 mm increments. To illustrate, disc 10 has one band on the shank 12 indicating that the thickness of disc 10 is 0.1 mm. Disc 20 has two bands on the shank 22 indicating that the thickness of disc 20 is 0.2 mm. Disc 30 has three bands on the shank 32 indicating that the thickness of disc 30 is 0.3 mm. Disc 40 has four bands on the shank 42 indicating that the thickness of disc 40 is 0.4 mm. Disc 50 has five bands on the shank 52 indicating that the thickness of disc 50 is 0.5 mm.

The thickness indicator can also be color coded using black, brown, red, orange, yellow, green, blue, violet, gray, white, gold and silver. Additionally, a tolerance indicator can be used. The colors can be painted on the disc or shank in the form of narrow bands, dots, or as a body color. The percent of tolerance in the resistance value may be indicated by a fourth band of color. In one exemplary system, the first figure of the thickness value is represented by one of the colors, the second figure is represented by another one of the colors, the number of zeros following the second figure is represented by the third color, and the percent tolerance in the indicated thickness value is represented by the fourth color.

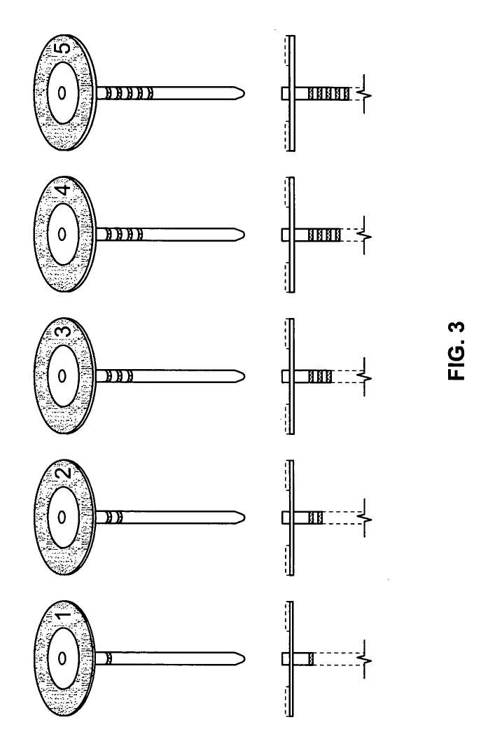

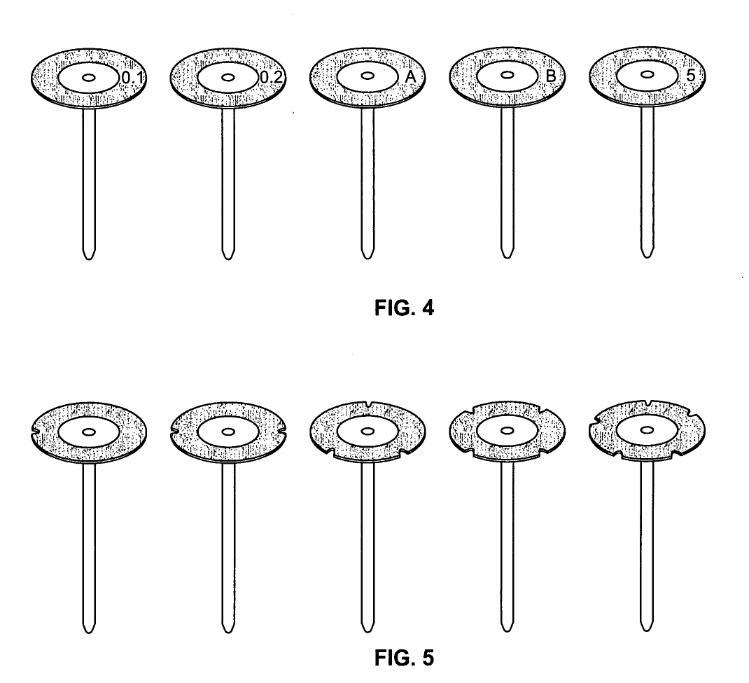

In other embodiments, the sequence of use can be indicated on the disc. For example, as shown in FIG. 3, the discs are labeled 1, 2, 3, 4 and 5. Additionally, the shanks also provide the thickness indicators thereon. However, for identification, the indicators only need to be on either the disc or the shank. Alphanumeric indicators and other graphic symbols may also be used as thickness indicators. The sequence can be any predetermined symbols as well. For example, FIG. 4 shows discs labeled with symbols 0.1, 0.2, A, B, and 5. In another embodiment, the thickness indicator can also be a circle on the disc, or other indicator such as notches/cutouts. For example, FIG. 5 shows discs whose sequence is indicated by the number of notches on the disc itself. The color of the disc itself can be used to indicate disc thickness.

In another embodiment, thinner discs may be indicated with a smaller diameter disc, while the thicker discs may be indicated by larger diameter discs, or vice versa, to indicate which discs in the sequence to use.

In yet another embodiment, the discs can have abrasives on top side, bottom side, or both and depending on the grit and location, will have an impact on the disc total thickness. The thicknesses of the top-sided, bottom-sided and dual-side coatings are then calibrated to set increments.

In another embodiment, the discs are indicated with the set increments. However, the actual disc thickness is slightly less than the indicated thickness value in order to accommodate user instrument movement such that the final amount is the increment indicated even though the disc itself is thinner than the indicated value.

Thus, a variety of indicators can be used to instruct the user of the thickness of the disc, including: stripes on the shank, stripes on the disc, notches on the wheel, cutouts in the wheel, colors, varying degrees of abrasive coating on the wheel, varying diameter of the wheel, varying lengths of the shank—all to indicate the calibration amount and the number in the series of discs corresponding to thickness.

Each disc surface can include diamond grains attached thereto to facilitate the IPR operation. In one embodiment, the diamond grains can be attached by electro-plating with nickel, etc., and diamond grains having a grain size of about 75 to 110 microns can be attached.

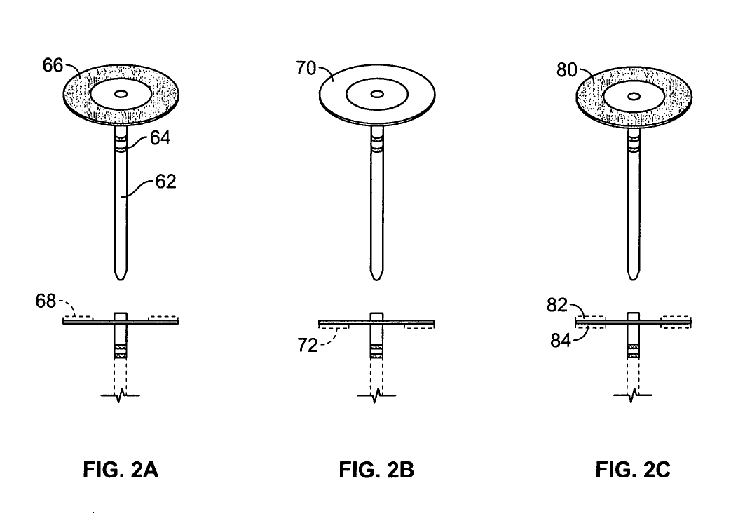

FIGS. 2A-2C illustrate in more detail the top side, bottom side and dual side abrasive positions. In FIG. 2A, a disc 66 has abrasives (68) mounted in a top side position. In FIG. 2B, a disc 70 has abrasives (72) mounted in a bottom side position. In FIG. 2C, a disc 80 has abrasives 82-84 mounted on both top and bottom sides of the disc 80.

As has been described above in detail, the combined disc/measurement system can shorten the period of time that a patient opens his or her mouth and can lower the IPR cutting time to a minimum, and hence, can greatly reduce discomfort to the patient during the creation of the gap between teeth.

While the invention has been described in detail and with reference to specific embodiments thereof, it will be apparent to one skilled in the art that various changes and modifications can be made therein without departing from the spirit and scope thereof.

What is claimed is:

1. A system to perform interproximal reduction, comprising:
a. a series of discs with disc thicknesses calibrated to preset increments; and
b. a shank coupled to each disc.

2. The system of claim 1, wherein the shank is received by a handpiece.

3. The system of claim 1, wherein each disc comprises an abrasive-coating.

4. The system of claim 1, wherein the increments comprise a sequence of 0.1 mm or a sequence of 0.25 mm increments.

5. The system of claim 1, wherein one of the discs comprises a top-sided coating.

6. The system of claim 1, wherein one of the discs comprises a bottom-sided coating.

7. The system of claim 1, comprising a coating on a disc surface.

8. The system of claim 7, wherein the coating covers a portion of the disc surface.

9. The system of claim 1, comprising coatings on both disc surfaces.

10. The system of claim 7, wherein the coatings cover portions of the disc surfaces.

11. The system of claim 1, wherein the thickness is reduced to accommodate user instrument movement such that the final amount is the increment indicated.

12. The system of claim 1, comprising a thickness indicator on the disc.

13. The system of claim 12, wherein the thickness indicator includes one of: a stripe, a color indication, an alphanumeric symbol, a graphic symbol, a notch, a cut-out, a disc diameter, and a coating level.

14. The system of claim 1, comprising a thickness indicator on the shank.

15. The system of claim 14, wherein the thickness indicator includes one of: a stripe on the shank, a color indication on the shank, the length of the shank.

16. The system of claim 1, comprising an indicator relating to calibration amount and disc thickness identification.

17. A method to perform interproximal reduction (IPR), comprising:
a. selecting a disc from a series of discs with disc thicknesses calibrated to preset increments, the disc coupled to a shank and adapted to form a preselected gap based on the disc thickness;
b. inserting the shank into a dental handpiece; and
c. applying the disc to a tooth to create the preselected gap.

18. The method of claim 17, comprising first selecting the thinnest disc in the series and subsequently using discs of different thicknesses until the desired thickness is achieved.

19. The method of claim 17, comprising selecting the disc based on a thickness indication on the shank.

20. The method of claim 17, comprising placing an abrasive-coating on each disc.

21. The method of claim 17, wherein the increments comprise a sequence of 0.1 mm or a sequence of 0.25 mm increments.
